(19) United States
(12) Patent Application Publication
(10) Pub. No.: US 2019/0087486 A1
(43) Pub. Date: Mar. 21, 2019

(54) ONTOLOGY BASED QUERY SUGGESTION USING EYE TRACKING

(71) Applicant: INTERNATIONAL BUSINESS MACHINES CORPORATION, Armonk, NY (US)

(72) Inventors: Ashish Mittal, Bengaluru (IN); Diptikalyan Saha, Bangalore (IN); Karthik Sankaranarayanan, Bangalore (IN); Jaydeep Sen, Bangalore (IN)

(21) Appl. No.: 15/710,979

(22) Filed: Sep. 21, 2017

(51) Int. Cl. G06F 17/30; G06F 3/01

(52) U.S. Cl. CPC G06F 17/30654; G06F 17/30675; G06F 17/30734; G06F 3/013

(57) ABSTRACT

The present invention may include a computing device receives a query and determines a plurality of implementations based on the query and searching the ontology driven system. The computing device may display the determined plurality of implementations and monitors the eye tracking datum for a fixation. The computing device may determine the corresponding plurality of implementations associated with a region where the fixation is directed based on determining the fixation. The computing device may determine a plurality of candidate elements of the plurality of implementations in the region based on previous determination of the corresponding plurality of implementations. The computing device may generate a plurality of preferred interpretations based on monitoring the eye tracking datum, the corresponding plurality of implementations associated with the region of the fixation, and the plurality of candidate elements.

### BACKGROUND

The present invention relates, generally, to the field of computing, and more particularly to improving Natural Language Processing (NLP) based on a user eye tracking while interacting with graphical user interface (GUI).

NLP is a field of computer science, artificial intelligence, and computational linguistics related to the interactions between computers and human natural languages, such as programming computers to process natural language corpora. A subfield of NLP is natural language understanding that relates to machine reading comprehension and allows for answering a question in a natural language by transferring the question into a computer searchable query. The machine reading comprehension may be achieved by ontology-based data integration. The ontology-based data integration is an effective combination of data from multiple heterogeneous sources that enable the unambiguous identification of elements in heterogeneous information system and assertion of applicable relationships that connect these elements together.

A GUI is a type of user interface that allows a user to interact with an electronic device, such as a computer, through visual indicators presented on a display of the electronic device.

### SUMMARY

According to one embodiment, a method, computer system, and computer program product for ontology based query suggestion using eye tracking is provided. The present invention may include a computing device receives a query and determines a plurality of implementations based on the query and searching the ontology driven system. The computing device may display the determined plurality of implementations and monitors the eye tracking datum for a fixation. The computing device may determine the corresponding plurality of implementations associated with a region where the fixation is directed based on determining the fixation. The computing device may determine a plurality of candidate elements of the plurality of implementations in the region based on previous determination of the corresponding plurality of implementations. The computing device may generate a plurality of preferred interpretations based on monitoring the eye tracking datum, the corresponding plurality of implementations associated with the region of the fixation, and the plurality of candidate elements.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating an ontology based query suggestion using eye tracking process according to at least one embodiment;

FIG. 3A is an example embodiment of a structure of the ontology driven system database in a financial domain, according to at least one embodiment;

FIG. 3B is an example embodiment of a display screen presenting the output consisting of different interpretation in consecutive order, according to at least one embodiment;

FIG. 3C represents a heat map and a fixation region according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to improving Natural Language Processing (NLP) based on a user eye tracking datum while interacting with a displayed graphical user interface (GUI). The following described exemplary embodiments provide a system, method, and program product to, among other things, improve NLP by dynamically generating query searches based not only on ontology derived interpretations but also on user eye tracking data, such as eye fixations on regions of interest. Therefore, the present embodiment has the capacity to improve the technical field of ontology-based query suggestion by understanding and determining user preferences while the user views the display and determining appropriate query suggestions using ontology and the determined user preferences.

As previously described, NLP is a field of computer science, artificial intelligence, and computational linguistics related to the interactions between computers and human natural languages such as programming computers to process natural language corpora.

Typically, a user may interact with a computing device using voice commands, such as asking questions in a natural language. In order to provide an answer, ontology driven systems may be utilized to determine the answer.

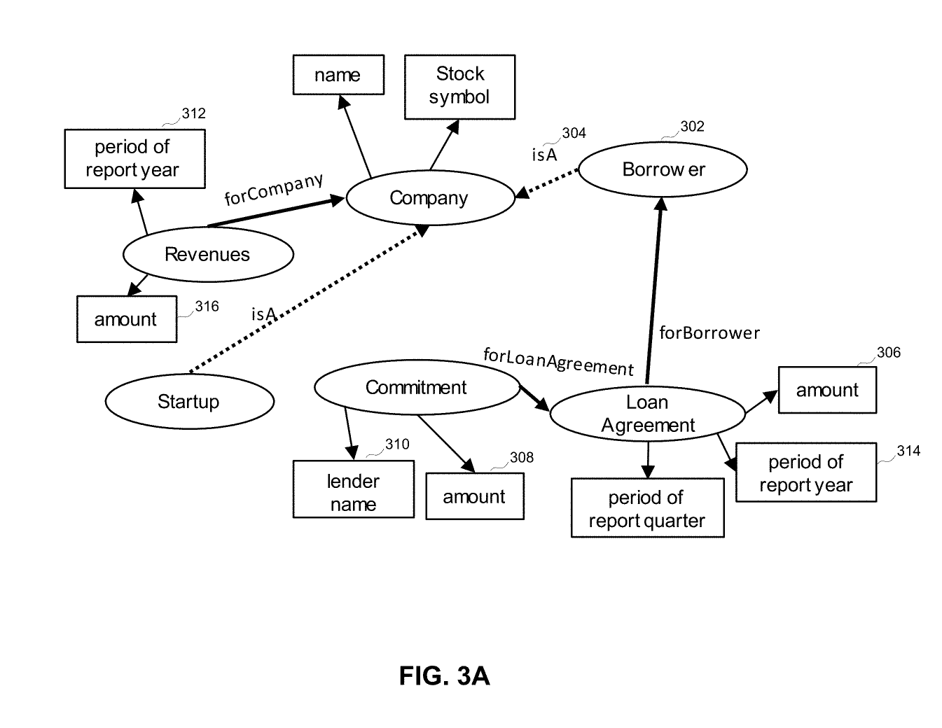

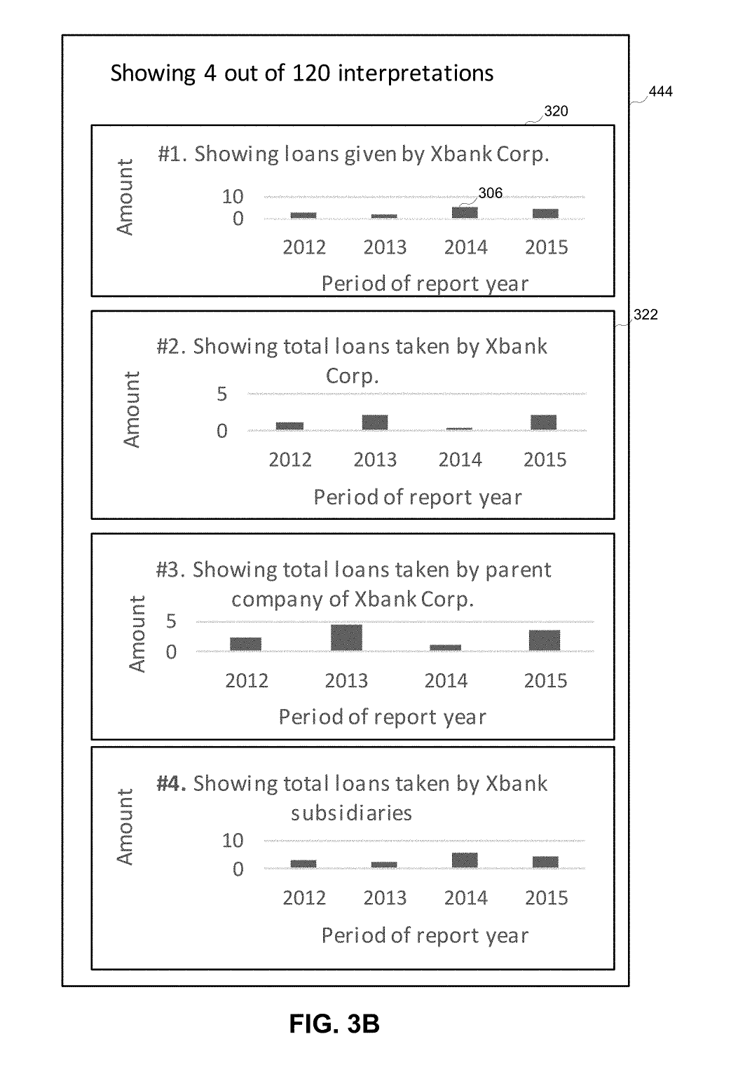

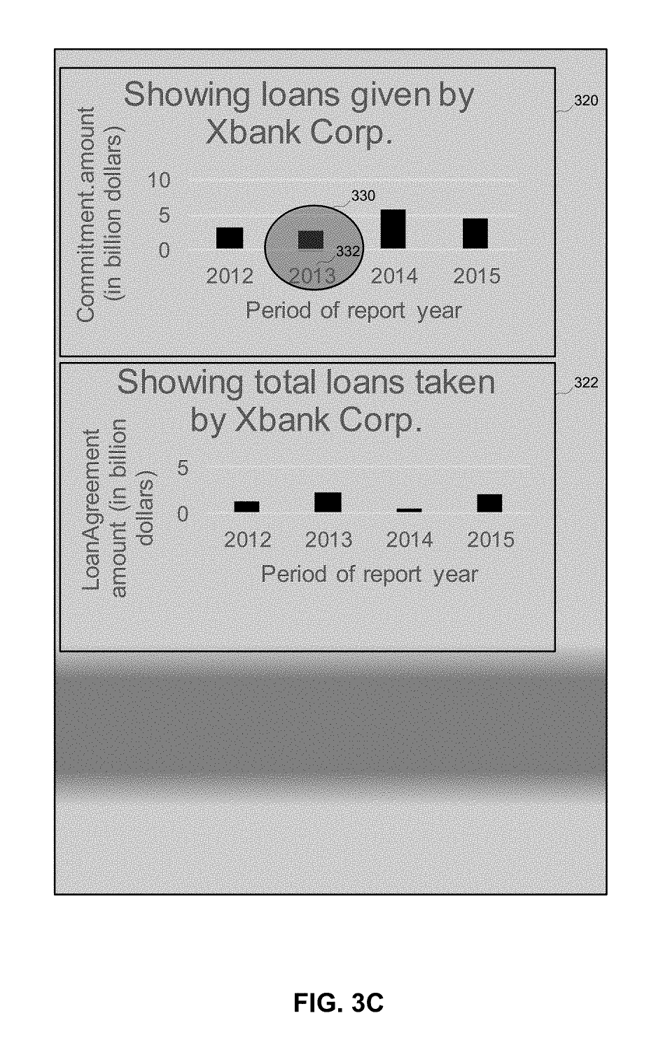

Ontology driven systems are based on “knowledge graph” structures that are stored in the form of searchable databases that include types, properties, and interrelationships of the entities or elements. These elements may be words, phrases, definitions, and acronyms that are typically used for a particular domain of discourse. For example, ATHENA ontology driven system has three different domains (i.e., geographic data, academic data, and financial data). An example embodiment of a structure of financial ontology driven system is depicted in FIG. 3A.

The ontology driven systems are configured to establish and determine relationships between entities in a question (query) and by using relations between various entities of the database datum, determine various interpretations (suggestions) that may be returned as an output to the query.

Generation of various query interpretations based on ontology driven systems may make determining a correct or user preferred answer without user active intervention in the answer generation process difficult. As such, it may be advantageous to, among other things, implement a system that determines various query suggestions and relevant elements in the ontology driven systems based on an eye tracking datum. The initial query suggestions may be associated with a question asked when the real user intentions are unclear. Presenting the output consisting of various answers to a user in a way that allows for analysis of the eye tracking datum in order to determine a user preferred answer and to dynamically generate additional suggestions based on interpretation that is derived from user fixations without user physical or active interaction. Thus, the method enables the computing device to determine an answer to a question without active user intervention, such as by forcing a user to utilize external devices.

According to one embodiment, the method may determine a plurality of suggested answers based on searching the ontology driven system. Then, the method may display the plurality of suggested answers and analyze the eye tracking datum to determine fixations in regions of interest for the user. The updated corresponding plurality of suggested answers associated with the regions of the fixation based on determining the fixation in the eye tracking datum may be determined. By dynamically determining the candidate elements in the region of interest and updating the preferred interpretations based on monitoring the eye tracking datum, the preferred answers may be generated without the user active intervention in the process of refining of the query suggestions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to receive a natural language query, and generate several interpretations using ontology driven system. Thereafter, the interpretations may be displayed to a user, used to analyze an eye tracking datum to determine a preferred query from various interpretations, and expand the candidate elements of the selected interpretation.

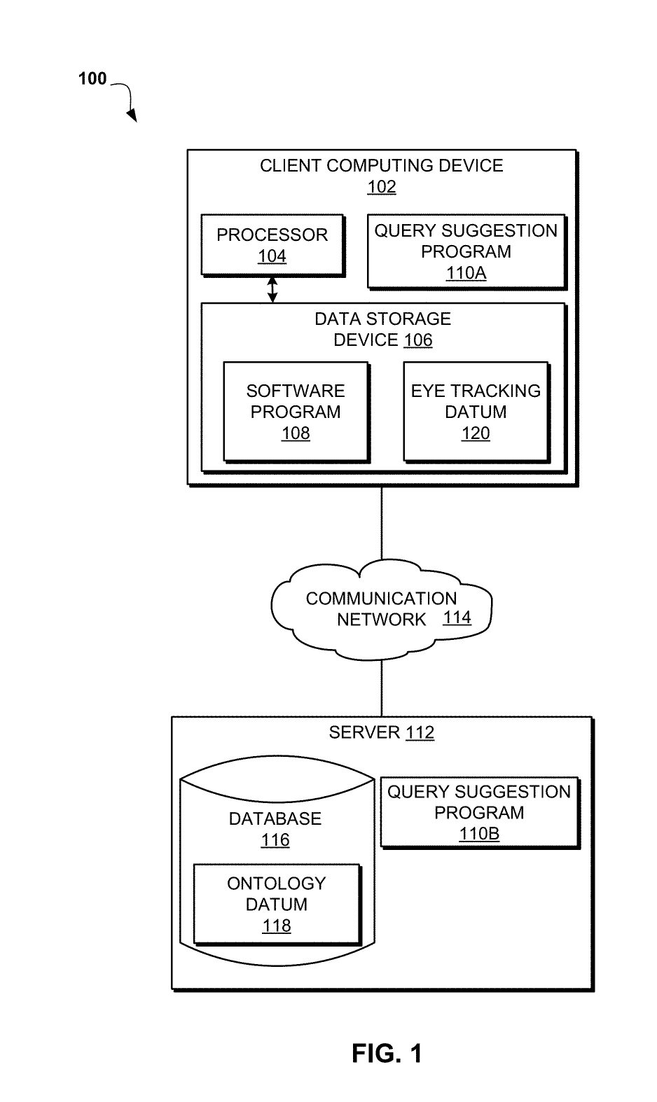

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

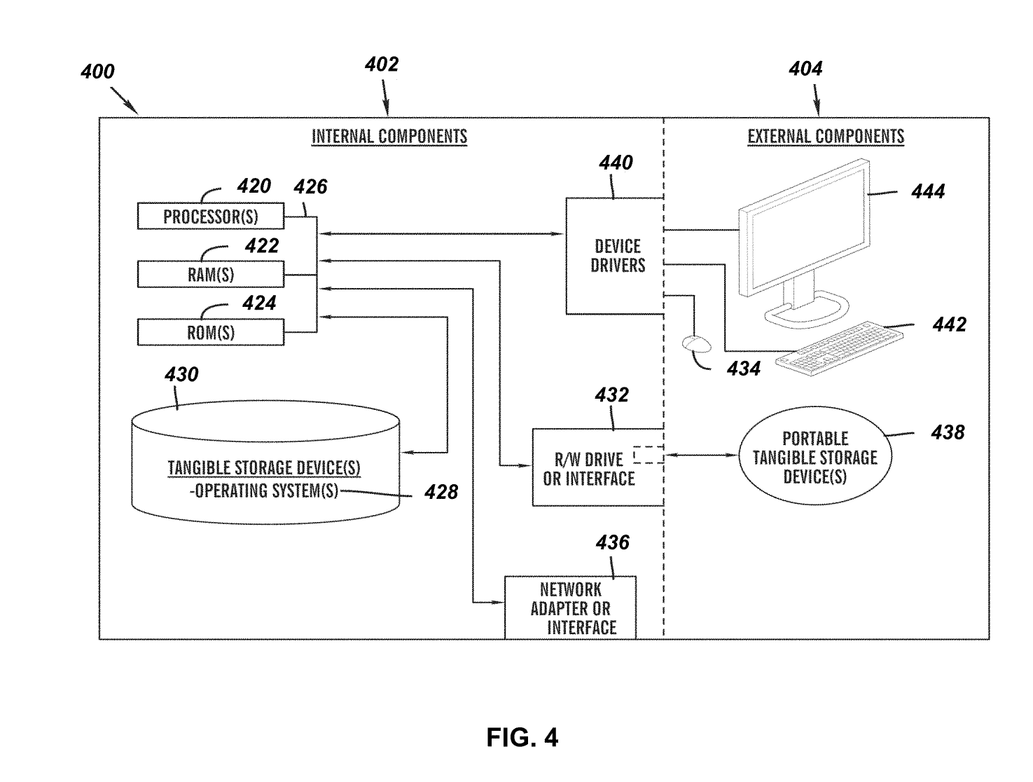

Client computing device 102 may include a processor 104 and a data storage device 106 that is enabled to host and run a software program 108, an eye tracking datum 120, and a query suggestion program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, a wearable device capable of executing a code and collecting a user eye tracking datum (i.e. contact lenses, glasses virtual reality glasses) or any type of computing device capable of running a program and accessing a network. As will be discussed with reference to FIG. 4, the client computing device 102 may include internal components 402a and external components 404a, respectively.

An eye tracking datum 120 may be a part of a commercially available software component that is configured to control a device or a sensor that measures a rotation of the eyes of a user that is operating client computing device 102 and stores the measurements in a database, such as database 116 or data storage device 106. The rotation of the eyes may be measured, for example, by recording an eye movement with a camera and determining a vector between the pupil center and a corneal reflection. The corneal reflection may be generated by an infrared light. After calibration, the angles and length of the vector may be transformed to a set of coordinates or a region on a display monitor. An eye tracking device may measure the rotation of eyes either optically, electrically, or using eye-attached objects, such as contact lens. According to an example embodiment, eye tracking datum 120 may be configured to record the data generated by the rotation of the eyes when the interpretations are displayed into the eye tracking datum 120, or to a device repository, such as database 116 or data storage device 106).

According to the present embodiment, eye tracking datum 120 may be a software component with an accessible database containing datum that stores eyes fixations of the user on interpretations and interpretation elements that are displayed on display monitor 444. Fixations are periods in which the eyes are motionless while observing a specific GUI element of the interpretation. For example, if the eyes of a user are motionless and the coordinates of the point of gaze fall within the coordinates of a GUI element of one of the interpretations, the user has a fixation on the GUI element of the interpretation. According to an example embodiment, a fixation datum may be used to determine user preferences as to a specific interpretation and a specific element of the interpretation. Fixation may be characterized using three measures: fixation count, total number of fixations on a specific area of the display monitor, and fixation duration. In addition, a total fixation time on a specific area of the display monitor and a first fixation time may be stored and analyzed for determining user preferences. In further embodiments, additional parameters may be stored in eye tracking datum, such as a start time representing a first fixation on one of the interpretations.

The server computer 112 may be a laptop computer, netbook computer, personal computer (PC), a desktop computer, or any programmable electronic device or any network of programmable electronic devices capable of hosting and running a query suggestion program 110B and a database 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

Database 116 may be a data repository capable of storing information, such as ontology datum 118. Ontology datum 118 may be an ontology driven system software and databases consisting of tables, matrixes, and spreadsheets, and a search engine that allows for submission of queries and receiving an output. As previously mentioned, ontology datum 118 may include words, phrases, definitions, and acronyms that may typically be used for a particular domain of discourse. For example, ontology datum 118 may be an ATHENA ontology driven system that has one of the following domains such as geographical, academic and financial datum. An example embodiment of a part of a financial ontology knowledge tree is depicted in FIG. 3A. Each entity from the knowledge tree may represent a word, phrase, abbreviation or other combination of alphanumeric natural language inputs. In another embodiment, ontology datum 118 may be located on data storage device 106 or loaded using internal components 502 a,b or external components 504 a,b.

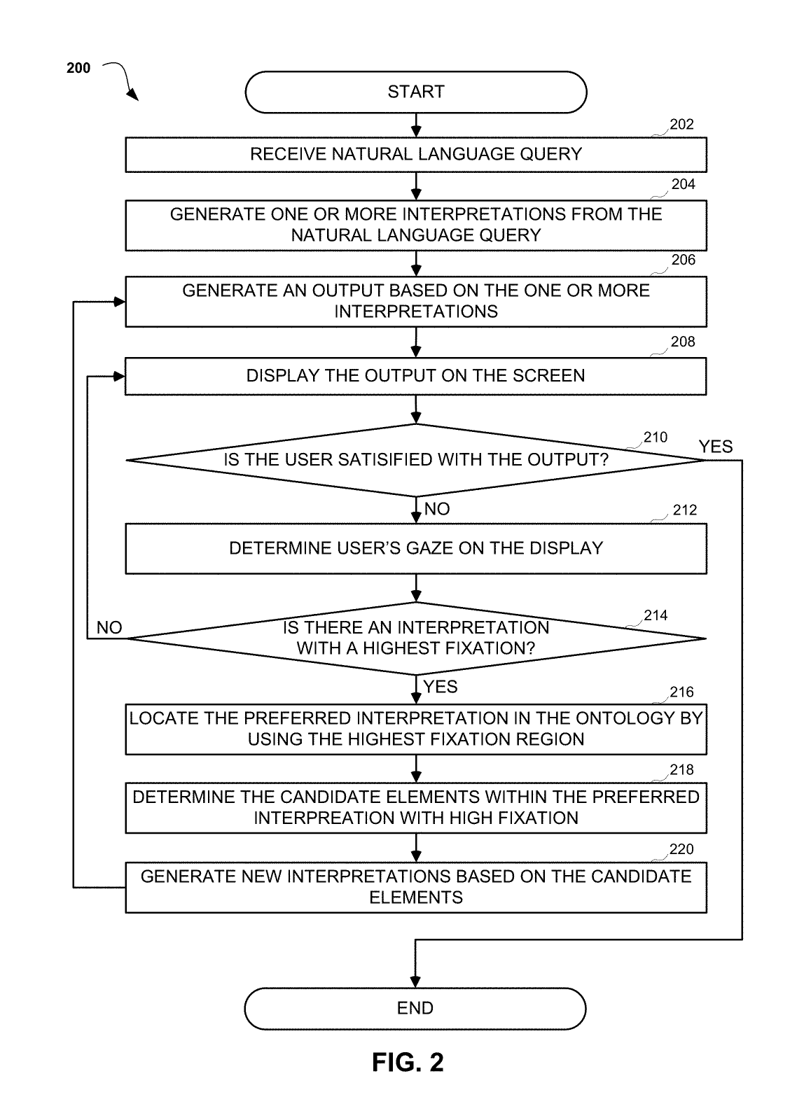

According to the present embodiment, the query suggestion program 110A, 110B may be a program capable of receiving a natural language query, generating interpretations and determining the preferred interpretation based on eye tracking data. The ontology-based query suggestion method is explained in further detail below with respect to FIG. 2.

Referring now to FIG. 2, an operational flowchart illustrating an ontology-based query suggestion using eye tracking process 200 is depicted according to at least one embodiment. At 202, the query suggestion program 110A, 110B receives a natural language query. A natural language query may be a question asked by a user in a natural language. The natural language query may be received from internal components 402 or external components 404 of client computing device 102, such as from a microphone, or in digital format, such as an audio file.

Next, at 204, the query suggestion program 110A, 110B generates one or more interpretations from the natural language query. According to the present embodiment, the query suggestion program 110A, 110B may convert the natural language input to text using known speech-to-text technology. The converted text may then be used to generate one or more interpretations by an ontology driven system that may be located in an ontology datum 118. According to the present embodiment, each interpretation may be a possible query that represents a natural language question asked by a user in a natural language.

Next, at 206, the query suggestion program 110A, 110B generates an output based on the one or more interpretations. According to the present embodiment, the interpretations may be translated to a domain specific language, such as Structured Query Language (SQL), and searched on the ontology datum 118. An output may be generated by the various query suggestions from the ontology datum 118 that are each a different interpretation of the natural language question asked by a user. For example, if the user asked a question “Show me Xbank Corp. loans” query suggestion program 110A, 110B may generate at least two suggestions where the loans are given or taken by Xbank Corp. An Xbank Corp. may also be interpreted by query suggestion program 110A, 110B as a generic bank or a specific bank and generate additional suggestions.

Next, at 208, the query suggestion program 110A, 110B displays the output on the screen. According to the present embodiment, the query suggestion program 110A, 110B may display the different interpretations on display monitor 444. For example, if the user asked a question “Show me Xbank Corp. loans” the ontology driven system may generate different interpretations due to the fact that it is unclear whether the Xbank Corp. gives loans or receives them. According to the present embodiment, the query suggestion program 110A, 110B may display the output consisting of different interpretations in consecutive order, such as displayed in FIG. 3B.

Then, at 210, the query suggestion program 110A, 110B determines whether the user is satisfied with the output. According to the present embodiment, a user may acknowledge that the user is satisfied with the output by interacting with an external components 404 of client computing device 102, such as by using keyboard 442 or computer mouse 434. For example, query suggestion program 110A, 110B may present a popup message requesting from a user to either input or “click” with computer mouse 434 that the user is satisfied with the output. In another embodiment, as will be explained in further detail referring to FIG. 3C, the query suggestion program 110A, 110B may flag the interpretation on which a user had more GUI object fixation. Therefore, repeatedly fixating on the same interpretation may be considered by the query suggestion program 110A, 110B as a user being satisfied with the output. As previously described, fixations may be periods in which the eyes are motionless while observing a specific GUI component of the interpretation. For example, if the eyes of a user are motionless and the coordinates of the point of gaze (fixation) fall within the coordinates of a GUI component of the interpretation, the user may be fixated on the interpretation. In further embodiments, user satisfaction may be inferred by the user fixating on a specific part of the display monitor that represents user satisfaction or dissatisfaction. If the query suggestion program 110A, 110B determines that a user is satisfied with the output (step 210, “YES” branch), the query suggestion program 110A, 110B may terminate. If the query suggestion program 110A, 110B determines that a user is not satisfied with the output (step 210, “NO” branch), the query suggestion program 110A, 110B may continue to step 212 to analyze eye tracking and determine the user's gaze on the display monitor.

Next, at 212, query suggestion program 110A, 110B determines user's gaze on the display monitor. According to the present embodiment, the query suggestion program 110A, 110B may access the datum from eye tracking datum 120 and determine the areas where a majority of fixations occurred. For example, the query suggestion program 110A, 110B may convert eye fixation locations on the display to a heat map and identify coordinates where the fixation times or counts are above a threshold value. In another embodiment, the query suggestion program 110A, 110B may identify and flag GUI elements of one or more of the interpretations displayed for future processing.

Then, at 214, the query suggestion program 110A, 110B determines whether there is an interpretation with a highest fixation. According to the present embodiment, the query suggestion program 110A, 110B may compare the counts of fixations and the times of fixations on a display and determine the set of coordinates with the highest fixation times and the highest fixation counts. The query suggestion program 110A, 110B may then determine an interpretation and an interpretation GUI element that is displayed at the same coordinates. For example, FIG. 3C represents a display with a circle 304 that may represent an interpretation with a highest fixation time. If the query suggestion program 110A, 110B determines that there is an interpretation with a highest fixation (step 214, “YES” branch), the query suggestion program 110A, 110B may continue to step 216 to use the highest fixation region and an ontology to locate the preferred interpretation in the ontology. If the query suggestion program 110A, 110B determines that there is no interpretation with a highest fixation (step 214, “NO” branch), the query suggestion program 110A, 110B may return to step 208 to display other interpretations that are not currently displayed.

Next, at 216, the query suggestion program 110A, 110B locates the preferred interpretation in the ontology by using the highest fixation region. According to the present embodiment, the query suggestion program 110A, 110B may determine the preferred interpretation by associating a highest fixation region with the interpretation displayed in the region of the display and determines the elements in the ontology that were used for generating the fixated interpretation. Once the query suggestion program 110A, 110B determines the elements used to generate the fixated interpretation, the query suggestion program 110A, 110B may flag the element. To continue our previous example, if the highest fixation of the user is on an interpretation that shows loans given by Xbank Corp. as depicted in FIG. 3C, the query suggestion program 110A, 110B may flag lender name element 310, amount element 306, and period of reported year element 314 (depicted in FIG. 3A) as related to the fixated interpretation and exclude the elements, such as revenue related period of reported year element 312 and revenue related amount element 316 because they relate to revenues that were not used for generating the fixated interpretation.

Next, at 218, query suggestion program 110A, 110B determines the candidate elements within the preferred interpretation with high fixation. According to the present embodiment, the query suggestion program 110A, 110B may determine the element that has a highest fixation within the fixated element in order to generate suggested interpretations. To continue our previous example, if a highest fixation is related to a graph element representing the loans given by Xbank Corp. during fiscal year 2013 as depicted at 332 in FIG. 3C, the query suggestion program 110A, 110B may suggest interpretations where element 314 (period of report year) is related only to the year of 2013.

Next, at 220, the query suggestion program 110A, 110B generates new interpretations based on the candidate elements. According to the present embodiment, the query suggestion program 110A, 110B may dynamically expand the interpretations that are related to the fixated interpretation and the candidate elements. To continue our example, the query suggestion program 110A, 110B may constantly monitor the eye tracking datum and generate additional interpretations that are related to the fixated interpretation and the candidate elements and also include additional elements related to the fixated interpretation, such as “show total loans given by Xbank Corp. by quarter”, “show borrowers of Xbank Corp. in 2013”, and “show Xbank Corp. loans taken by startups in 2013”.

It may be appreciated that FIG. 2 provides only an illustration of one implementation and does not imply any limitations with regard to how different embodiments may be implemented. Many modifications to the depicted environments may be made based on design and implementation requirements.

Referring now to FIG. 3A, an example embodiment of a structure of the ontology driven system database in a financial domain is depicted, according to at least one embodiment. As previously mentioned, the ontology driven systems are based on a knowledge graphs that consist of elements and relations between the elements. Borrower element 302 may represent a field that includes borrower names. Relations between the elements, such as relation 304, may represent an ontological connection between the elements, such as the relation that the borrower element 302 is a company. Amount element 306 may represent a loan agreement amount field, such as a loan amount element, represented in FIG. 3B. Additionally, amount element 316 may also represent an amount that is ontologically connected to revenue and, therefore, may represent revenue amounts, such as Xbank Corp.'s revenue during 2014. Amount element 308 may represent a commitment amount. Lender name 310 may represent a commitment related to a lender name. Period of reported year element 312 may represent a year of reported revenues, while period of reported year element 314 may be related to the year with which the loan agreement applies. For example, implementation 322 may display loan commitments taken by Xbank Corp. during years 2012-215.

Referring now to FIG. 3B, an example embodiment of a display screen 444 (see FIG. 4) presenting the output consisting of different interpretations in consecutive order is depicted, according to at least one embodiment. As previously mentioned, the interpretations may be displayed in a consecutive order such as interpretation 320 and 322 and when the user has no fixations on the display query suggestion program 110A, 110B may show other interpretations that were not presented before.

Referring now to FIG. 3C, a heat map and a fixation region are depicted, according to at least one embodiment. As previously mentioned, the eye tracking datum may be transferred to a heat map that may infer user preferences or an area of interest while observing the displayed interpretations. For example, region 320 is depicted in a darker than region 322, therefore the user may have more fixations in a region associated with a first displayed interpretation. Region 330 represents eye fixation of the user on an element of the first displayed interpretation. Region 330 may assist the query suggestion program 110A, 110B to determine the element in which the user is interested and dynamically generate additional interpretations around the element of interest, such as loans given by Xbank Corp. during a fiscal year of 2013.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the query suggestion program 110A in the client computing device 102, and the query suggestion program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the query suggestion program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the query suggestion program 110A in the client computing device 102 and the query suggestion program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the query suggestion program 110A in the client computing device 102 and the query suggestion program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

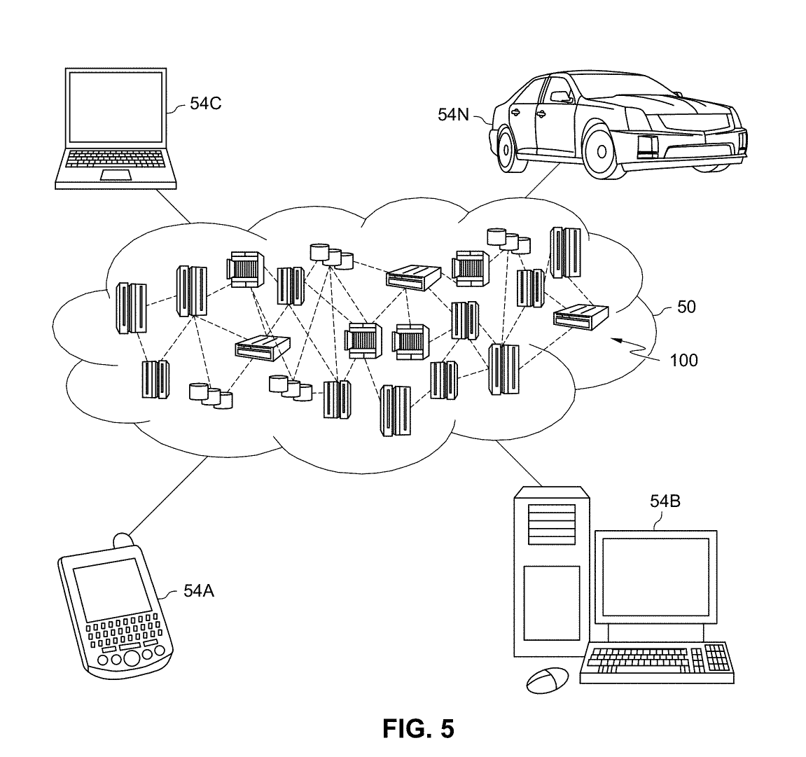

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

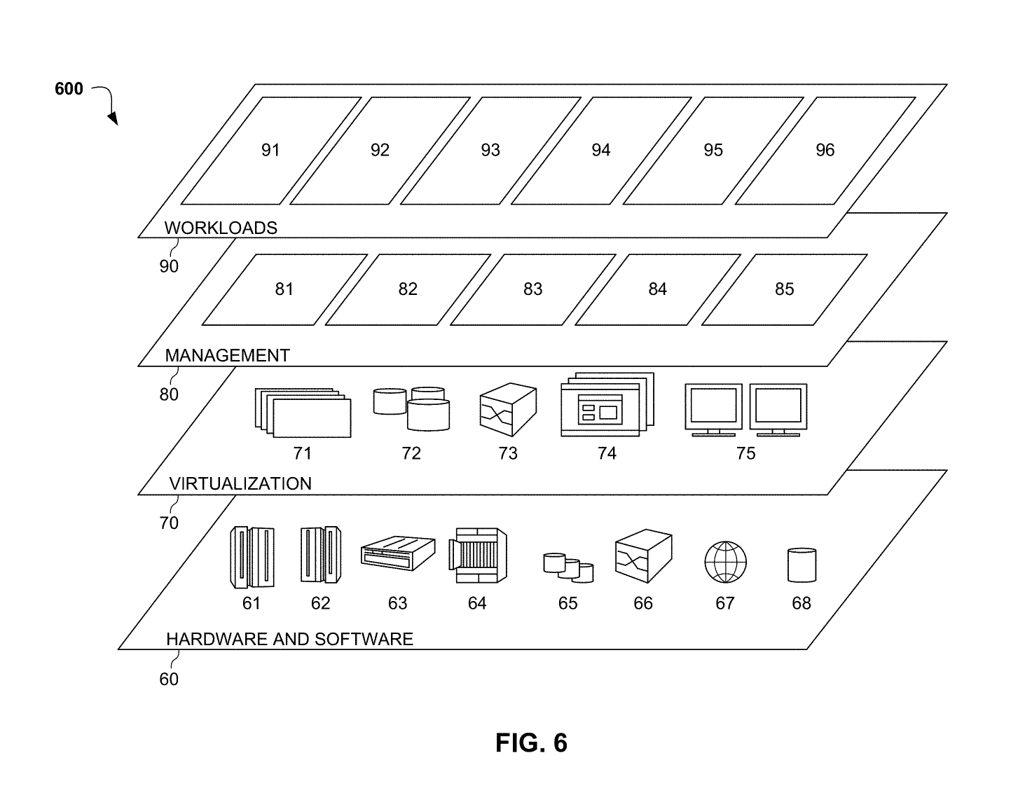

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and query suggestion processing 96. Query suggestion processing 96 may relate to receiving natural language question, determining query suggestions and the corresponding elements in the ontology based knowledge graph that may be associated with the answer, and, thereafter, presenting the various answers to a user while analyzing the eye tracking datum in order to determine user preferences and generate a preferred answer that corresponds to the user preferences.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for providing a plurality of query suggestions in an ontology driven system using an eye tracking datum, the method comprising:
receiving, by a processor, a query;
determining a plurality of implementations based on the query and searching the ontology driven system;
displaying the determined plurality of implementations;
monitoring the eye tracking datum for a fixation;
based on determining the fixation, determining the corresponding plurality of implementations associated with a region where the fixation is directed;
based on determining the corresponding plurality of implementations, determining a plurality of candidate elements of the plurality of implementations in the region; and
generating a plurality of preferred interpretations based on monitoring the eye tracking datum, the corresponding plurality of implementations associated with the region of the fixation, and the determined plurality of candidate elements.

2. The method of claim 1, wherein the ontology driven system is based on a knowledge graph structure that is stored in a form of a plurality of searchable databases, wherein each field of the plurality of searchable databases is associated with an element of the knowledge graph.

3. The method of claim 1, wherein determining a plurality of implementations based on searching the ontology driven system further comprises:
determining one or more elements from the received query;
associating the one or more elements with one or more elements of the ontology driven system; and
determining the plurality of implementations based on the associated one or more elements of the ontology.

4. The method of claim 1, wherein monitoring the eye tracking datum to determine a fixation further comprises:
determining one or more periods in which a user's eyes are motionless while observing a graphic user interface element of an interpretation within the displayed plurality of implementations; and
determining the fixation in the one or more periods where the user's eyes are motionless above a threshold time period.

5. The method of claim 1, wherein receiving, by the processor, the query comprises:
receiving a natural language question wherein the received query is a natural language question; and
converting the natural language question to a query using a speech-to-text technique, wherein the query is searchable by the ontology driven system.

6. The method of claim 1, wherein a region of the fixation is an area of a display where a user's eyes are motionless above a threshold time period.

7. The method of claim 1, wherein an ontology driven system is an ATHENA ontology driven system.

8. A computer system for providing a plurality of query suggestions in an ontology driven system using an eye tracking datum, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving, by a processor, a query;
determining a plurality of implementations based on the query and searching the ontology driven system;
displaying the determined plurality of implementations;
monitoring the eye tracking datum for a fixation;
based on determining the fixation, determining the corresponding plurality of implementations associated with a region where the fixation is directed;
based on determining the corresponding plurality of implementations, determining a plurality of candidate elements of the plurality of implementations in the region; and
generating a plurality of preferred interpretations based on monitoring the eye tracking datum, the corresponding plurality of implementations associated with the region of the fixation, and the determined plurality of candidate elements.

9. The computer system of claim 8, wherein the ontology driven system is based on a knowledge graph structure that is stored in a form of a plurality of searchable databases, wherein each field of the plurality of searchable databases is associated with an element of the knowledge graph.

10. The computer system of claim 8, wherein determining a plurality of implementations based on searching the ontology driven system further comprises:
determining one or more elements from the received query;
associating the one or more elements with one or more elements of the ontology driven system; and
determining the plurality of implementations based on the associated one or more elements of the ontology.

11. The computer system of claim 8, wherein monitoring the eye tracking datum to determine a fixation further comprises:
determining one or more periods in which a user's eyes are motionless while observing a graphic user interface element of an interpretation within the displayed plurality of implementations; and
determining the fixation in the one or more periods where the user's eyes are motionless above a threshold time period.

12. The computer system of claim 8, wherein receiving, by the processor, the query comprises:
receiving a natural language question wherein the received query is a natural language question; and
converting the natural language question to a query using a speech-to-text technique, wherein the query is searchable by the ontology driven system.

13. The computer system of claim 8, wherein a region of the fixation is an area of a display where a user's eyes are motionless above a threshold time period.

14. The computer system of claim 8, wherein an ontology driven system is an ATHENA ontology driven system.

15. A computer program product for providing a plurality of query suggestions in an ontology driven system using an eye tracking datum, the computer program product comprising:
one or more computer-readable tangible storage medium and program instructions stored on at least one of the one or more tangible storage medium, the program instructions executable by a processor, the program instructions comprising:
program instructions to receive, by a processor, a query;
program instructions to determine a plurality of implementations based on the query and searching the ontology driven system;
program instructions to display the determined plurality of implementations;
program instructions to monitor the eye tracking datum for a fixation;
based on determining the fixation, program instructions to determine the corresponding plurality of implementations associated with a region where the fixation is directed;
based on determining the corresponding plurality of implementations, program instructions to determine, a plurality of candidate elements of the plurality of implementations in the region; and
program instructions to generate, a plurality of preferred interpretations based on monitoring the eye tracking datum, the corresponding plurality of implementations associated with the region of the fixation, and the determined plurality of candidate elements.

16. The computer program product of claim 15, wherein the ontology driven system is based on a knowledge graph structure that is stored in a form of a plurality of searchable databases, wherein each field of the plurality of searchable databases is associated with an element of the knowledge graph.

17. The computer program product of claim 15, wherein program instructions to determine a plurality of implementations based on searching the ontology driven system further comprises:
program instructions to determine one or more elements from the received query;
program instructions to associate the one or more elements with one or more elements of the ontology driven system; and
program instructions to determine the plurality of implementations based on the associated one or more elements of the ontology.

18. The computer program product of claim 15, wherein program instructions to monitor the eye tracking datum to determine a fixation further comprises:
program instructions to determine one or more periods in which a user's eyes are motionless while observing a graphic user interface element of an interpretation within the displayed plurality of implementations; and
program instructions to determine the fixation in the one or more periods where the user's eyes are motionless above a threshold time period.

19. The computer program product of claim 15, wherein program instructions to receive, by the processor, the query comprises:
program instructions to receive a natural language question wherein the received query is a natural language question; and
program instructions to convert the natural language question to a query using a speech-to-text technique, wherein the query is searchable by the ontology driven system.

20. The computer program product of claim 15, wherein a region of the fixation is an area of a display where a user's eyes are motionless above a threshold time period.
